(19) United States
(12) Patent Application Publication
(10) Pub. No.: US 2004/0218204 A1
(43) Pub. Date: Nov. 4, 2004

(54) Printer

(75) Inventor: Reiko Nomura, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/644,095

(22) Filed: Aug. 20, 2003

(30) Foreign Application Priority Data
Aug. 22, 2002 (JP) 2002-242319
Aug. 8, 2003 (JP) 2003-290178

(51) Int. Cl. G06F 15/00

(52) U.S. Cl. 358/1.14; 358/1.16

(57) ABSTRACT

The invention enables a print job cancel from a printer panel and an avoidance of a waste print. Also, the invention enables the waste print even when a network emergency occurs. A printer which receives print data from a host and prints an image corresponding to the print data, includes: printing cancellation means which, during the printing of an image corresponding to received print data, in response to a printing cancellation request operation on an operating (S40) panel of the printer, halt the printing, perform discarding processing (S70) of the received print data up to a code which indicates a predetermined end-point, and transmit a data cancellation request (S90) to have the host halt a transmission of print data; and internal reset processing means which, in response to a reset command (S100) transmitted from the host in response to said data cancellation request, perform an internal reset processing (S120) to scrap received print data and transmit to the host a status response (S110) indicating that cancellation is underway. Since the printer halts printing and perform discarding processing of the received print data up to the predetermined code, it is possible to avoid the waste print.

### BACKGROUND OF THE INVENTION

1. Field of the Invention

The present invention relates to a printer, and more specifically to a printer in which print jobs can be canceled from a printer panel.

2. Background Art

Conventionally, to cancel printing while a printer prints data from a host computer, a method of selecting “cancel printing” on a screen of the host computer has been used. In this case, an RS (reset) command is transmitted from the host side to the printer side and a printer driver on the host side scraps the print data.

Alternatively, a method of selecting “cancel printing” on a screen of a spooler in the OS (operating system) of the host computer has been used. In this case, the data stored in the spooler are deleted.

When printing is canceled on the printer side, as disclosed in Japanese Unexamined Patent Application Publication 2000-289297 (Patent Document 1), for example, received print data are discarded (erased) without being printed. According to this publication, the printer begins printing upon reception of print data from a host. If the printer is reset thereafter, the print data of the job in progress become waste print data. The printer does not print these waste print data, but discards (erases) the data from a reception buffer upon reception without analyzing the data.

Japanese Unexamined Patent Application Publication H10-44557 (Patent Document 2) discloses an example of forcibly stopping a printer. In this example, when an error or the like is generated in the printer, the printer can be stopped forcibly at the printer side only. More specifically, the printer begins printing upon reception of print data from a host. When a forcible stop SW (switch) on the printer side is depressed following the occurrence of an error, an error signal output is transmitted from the printer to the host, whereby the host is temporarily halted and ceases to transfer print data to the printer. In the meantime, the printer illuminates an error LED, and then, in succession, clears the RAM to erase the print data, halts printing, and discharges the paper. When the printer error is removed, the printer transmits an error removal signal to the host and extinguishes the error LED.

In Japanese Unexamined Patent Application Publication 2002-200825 (Patent Document 3), a further method is proposed in which the printer notifies the host that a job is to be canceled in response to a job cancellation from a panel on the printer, and in response thereto, the host transmits to the printer print data to which an end mark signifying the end of the job is attached. The printer scraps the received print data up to the end mark and does not print the waste print data.

[Patent Document 1]

Japanese Unexamined Patent Application Publication 2000-289297

[Patent Document 2]

Japanese Unexamined Patent Application Publication H10-44557

[Patent Document 3]

Japanese Unexamined Patent Application Publication 2002-200825, corresponding US Publication 2002-21453, corresponding EP1174789

In the prior art, however, a problem arises in that when an operator wishes to cancel printing due to a mistake in the size of the paper, confusion between cut paper and roll paper, and so on, the operator has to take the trouble to move to the location of the host computer and select (click) “cancel printing” on the screen, and thus a number of wasteful steps are required.

Moreover, when the printer is reset or the power of the printer itself is cut off, print data continue to be transmitted from the host computer through a driver (spooler) thereafter. Hence when the printer is reactivated, these print data are all printed as waste, causing large amounts of paper, ink, and so on to be wasted, which is uneconomical.

In the case of Japanese Unexamined Patent Application Publication 2000-289297, when the printer is reset, received data on the printer side are discarded without being analyzed (data discarding mode). However, the host side is not informed that the printer has been reset, and hence the host computer continues to transmit print data. As a result, even when a normal connection is reestablished on the printer side, the printer merely discards data. This causes a problem in that time is wasted until data discarding is complete.

In the case of Japanese Unexamined Patent Application Publication H10-44557, description is provided to the effect that when printer initialization is complete, an error removal signal is transmitted to the host computer and the host resumes print data transfer, but no further description is provided.

In the case of Japanese Unexamined Patent Application Publication 2002-200825, the point up to which print data are to be scrapped can only be determined if the end mark serving as a job end command is received from the driver. Hence if an error occurs on the network, print data to be canceled cannot be scrapped appropriately and it may become impossible to print subsequent print jobs appropriately.

### SUMMARY OF THE INVENTION

It is therefore an object of the present invention to provide a printer in which printing can be completed without performing wasteful printing and without the operator's need to move to a host computer, and in which the time required to resume normal operations is shortened.

A further object of the present invention is to provide a printer in which a print job can be canceled so as to avoid waste printing even when a command cannot be received from a driver due to the occurrence of an emergency situation.

In order to achieve these objects, a first aspect of the present invention is a printer in which a data cancellation request is supplied to a host in response to an operation on the printer, whereby print data held by the host are erased. Since the host is caused to erase the data, wasteful print data are not transmitted to the printer.

A preferred embodiment of this invention is a printer in which printing corresponding to received print data is halted in response to an operation on the printer. The waste data already received are discarded without being printed.

A further preferred embodiment of this invention is a printer in which the host is caused to transmit an initialization request to the printer in response to the operation on the printer, whereby, in response to this initialization request, the interior of the printer is initialized.

According to the present invention described above, a printer can be provided in which printing can be completed without performing wasteful printing and without the operator's need to move to the host computer, and in which the amount of time required to return to normal operations is shortened.

### BRIEF DESCRIPTION OF THE DRAWINGS

FIG. 1 is a view showing the basic constitution of a printer in an embodiment of the present invention;

FIG. 2 is a flowchart showing an operation of the printer in this embodiment of the present invention;

FIG. 3 is a sequence chart between the printer and a host in this embodiment of the present invention;

FIGS. 4A and 4B are views showing an example of a printed image and the print data thereof;

FIGS. 5A and 5B are views showing an example of a printed image and waste printing;

FIG. 6 is a sequence chart in a modified example of this embodiment;

FIG. 7 is a view showing the constitution of print data in a second embodiment;

FIG. 8 is a sequence chart according to which a print job is canceled from a panel switch on the printer in the second embodiment;

FIGS. 9A and 9B are views illustrating an operation on the driver side in response to a job cancellation request in the second embodiment;

FIG. 10 is a sequence chart illustrating print job cancellation when an emergency situation such as a network connection error arises; and

FIG. 11 is a sequence chart of a case in which a print job is canceled from the host side.

### DETAILED DESCRIPTION OF THE PREFERRED EMBODIMENTS

Embodiments of the present invention will be described below with reference to the drawings. However, these embodiments do not limit the technical scope of the present invention, and extend to the claimed inventions and equivalents thereto.

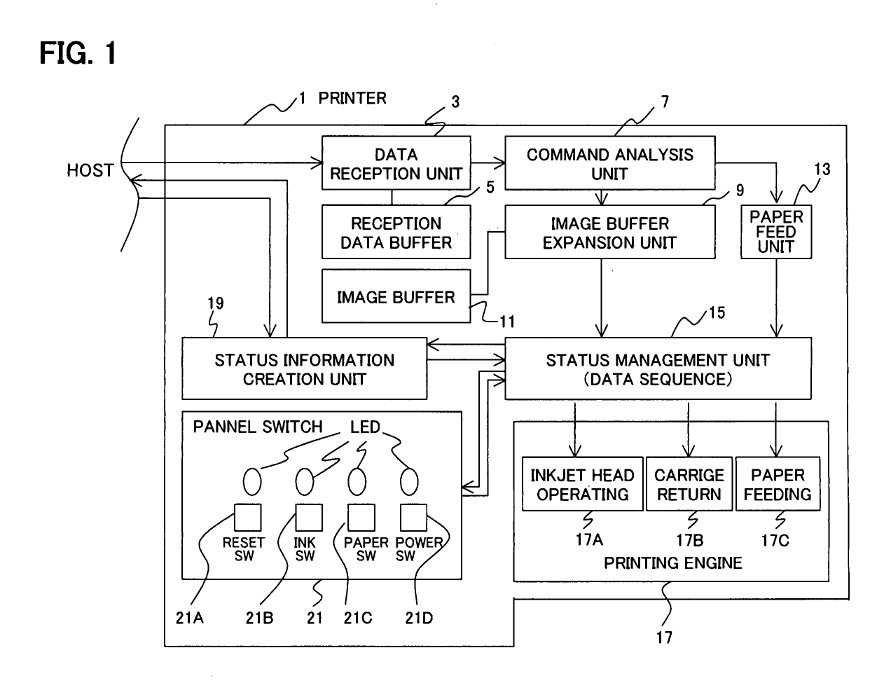

FIG. 1 is a view showing the basic constitution of a printer in an embodiment of the present invention. As shown in FIG. 1, a printer 1 of this embodiment comprises a data reception unit 3 for receiving print data from a host not shown in the drawing, a reception data buffer 5 for temporarily holding the received data, and a command analysis unit 7 for analyzing the received data.

The command analysis unit 7 analyzes data and transmits the analyzed data to an image buffer expansion unit 9, and also transmits a paper feed signal to a paper feed unit 13. The image buffer expansion unit 9 expands the print data transmitted from the command analysis unit 7 in to an image buffer 11 as printed image data, and transmits these printed image data to a status management unit 15.

Meanwhile, the paper feed unit 13 transmits a paper feed command to the status management unit 15. In response to this paper feed command, the status management unit 15 drives a printing engine 17 such that paper is transmitted to a paper feeding unit 17C.

The status management unit 15 drives the printing engine 17 as described above while maintaining the order in which the data are to be printed (job management, or in other words the printing sequence). The printing engine 17 is constituted by an ink jet head operating unit 17A, a carriage return unit 17B, the paper feeding unit 17C, and so on, and executes printing by controlling each of these mechanically operating parts.

The status management unit 15 also receives status requests from the host through a status information creation unit 19. The status management unit 15 responds to the status request to the printer to provide the host with a status information response through the status information creation unit 19. Information regarding the printer is included in this status information, and when an error occurs on the printer side such as paper depletion, a paper jam, or ink depletion, the printer provides a status information response to which error information is attached.

When error information is attached to the status information response, the host does not transmit print data to the printer thereafter. The host continues to request status information until it receives a status information response indicating that the printer is operating normally. Then, when the host determines from the provided status information response that no errors are present on the printer side and printing can be performed, the host resumes the transmission of print data to the printer.

The status management unit 15 can also be controlled by depressing switches on a panel switch 21 of the printer, and conversely, the status management unit 15 displays the status of the printer by controlling a light-emitting portion corresponding to the depressed switch. The light-emitting portion may be the panel switch of the printer itself, an LED corresponding to each of the switches, or similar. The printer panel switch comprises a reset switch 21A, an ink switch 21B, a paper switch 21C, a power switch 21D, and so on, for example.

By depressing the printer panel switch, an operator transmits a command to the status management unit 15 and thus controls the printer. In response to the command, the status management unit 15 illuminates the depressed switch, causes the switch to flash, or otherwise manipulates the switch, and thus the status of the printer is transmitted to the operator.

Next, an operation of the printer constituted as described above when a desire to cancel print data during printing arises due to mistaken paper size, confusion between cut paper and roll paper, and soon will be described.

When, for example, the paper switch 21C on the panel switch 21 is depressed, the printer determines that the print data currently being printed are to be canceled. As a rule, the paper switch 21C is not manipulated during printing, and hence the paper switch may be used to request cancellation. At this time, the status management unit transmits a data cancellation request to the status information creation unit 19.

The status management unit 15 causes the light-emitting portion of the LED or the like corresponding to the depressed paper switch 21C to flash at high speed, for example. Thus the operator who pressed the switch is able to recognize that a data cancellation request has been transmitted to the status information creation unit 19.

The status information creation unit 19 adds the data cancellation request to the status information and transmits this to the host. Upon reception of the status information, the host erases the data of the job for which the cancellation request is received. If the host is holding a plurality of jobs, only the job for which cancellation has been requested is canceled, and the remaining jobs are not canceled.

Thus in the printer according to this embodiment, in response to an operation on the printer side, for example the depression of a switch on the panel switch, the status management unit 15 transmits a data cancellation request to the status information creation unit 19, and the status information creation unit 19 attaches the data cancellation request to the status information and transmits this to the host. The host erases the data corresponding to the cancellation request from the printer, and thus an operator simply has to perform an operation on the printer without going to the trouble of moving to the location of the host to erase the data held by the host.

The status management unit 15 then controls the printing engine 17 such that one sheet of the paper which was used during printing is discharged, and then halts each function of the printing engine 17. The mechanically operating parts such as the motor are all stopped.

From this time, the printer enters a data discarding mode. That is, print data that have already been read until a switch is depressed are discarded. Here, discarding means that read data are not printed. This includes deleting data from the buffers and standing by with read data in the buffers.

By providing the host with the aforementioned data cancellation request-attached status information, the printer causes the host to transmit to the printer a reset command.

It is important to clarify here that resetting is not performed on the printer side, but rather the host is caused to transmit a reset command.

If resetting is performed independently on the printer side, the host is not notified that the printer is being reset, and hence the host does not detect that the printer is being reset. As a result, the host continues to transmit more and more print data to the printer even while the printer is performing a reset operation. When the printer completes the reset operation and resumes printing, the print data transmitted by the host during the reset operation might be printed as waste.

In the printer of this embodiment, however, the host is provided with the data cancellation request-attached status information, and once the host has received the status information response, no more data are transmitted to the printer. Further, since the host is caused to transmit a reset command, the host can detect that the printer is being reset. Hence the printer can avoid wasteful printing.

The status management unit 15 waits until the reset command from the host is received, and after receiving the reset command, responds thereto with a status information response stating that a reset operation is underway.

The status information that a reset operation is underway is effective when a plurality of hosts are connected to a printer, for example. This is because although the host which transmitted the reset command to the printer knows that the printer is being reset, the other host does not know. The host which did not transmit the reset command learns that the printer is being reset upon reception of the status information that a reset operation is underway. Thereafter, similarly to the host which transmitted the reset command, this host transmits no more print data.

Next, the printer swiftly executes internal reset processing. By means of this processing, all data stored in the RAM, such as in the internal reception data buffer and image buffer of the printer, are cleared.

When printer reset processing is complete, the status management unit 15 transmits a status signal indicating normal status to the host via the status information creation unit 19. The host resumes normal printing processing from the subsequent job to the job which was canceled following reception of a cancellation request.

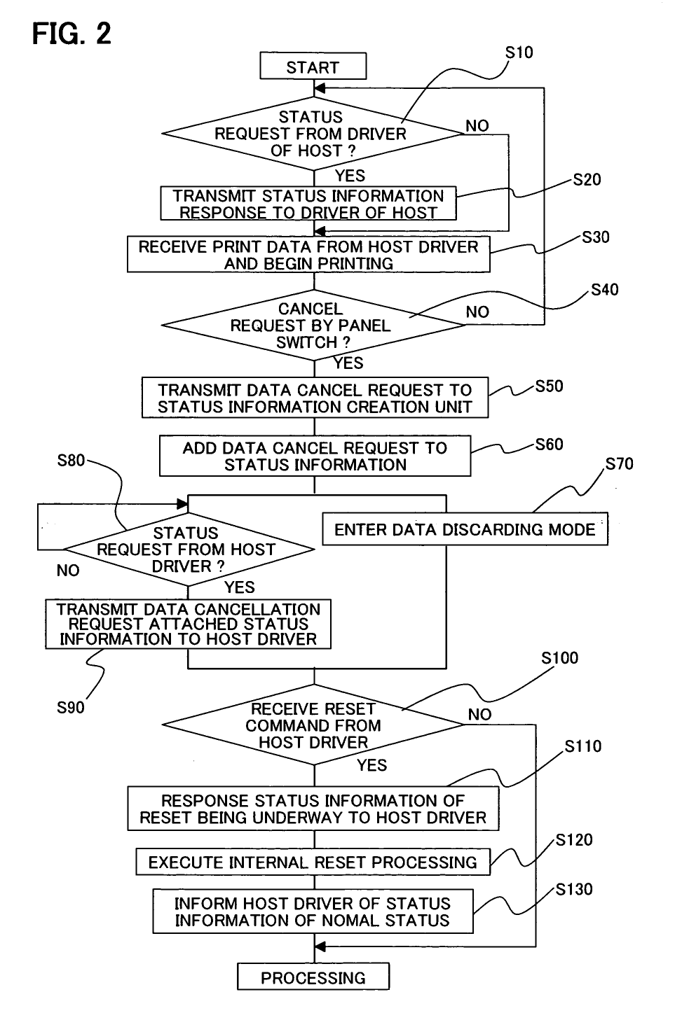

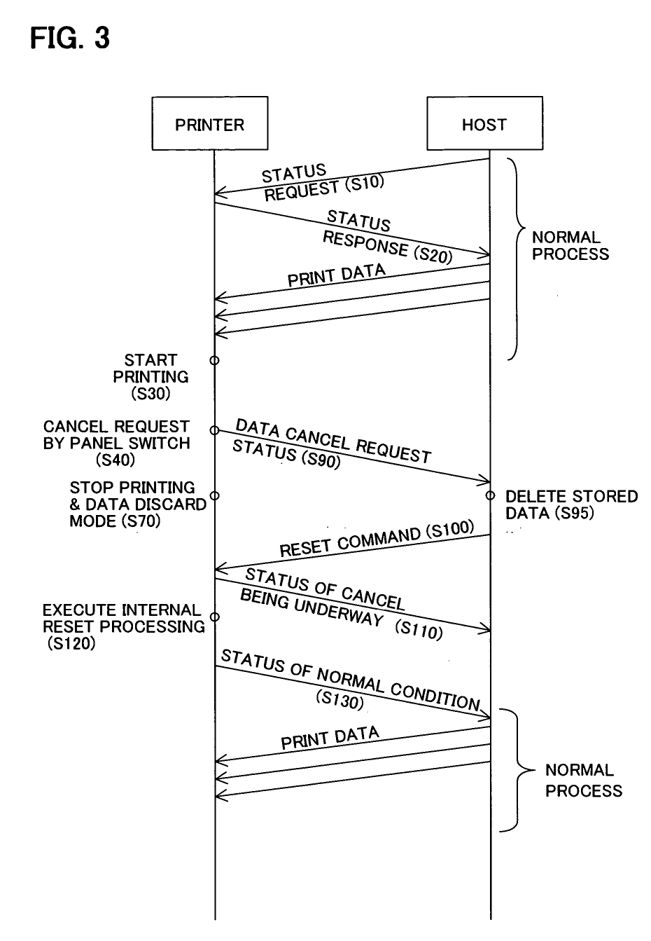

FIG. 2 is a flowchart showing an operation of the printer in this embodiment of the present invention. FIG. 3 is a sequence chart between the host and printer in this embodiment of the present invention. FIGS. 2 and 3 will be used below to explain the bi-directional control with the host. Identical reference symbols are used for identical parts in FIGS. 2 and 3.

When an operation of the printer begins, the host (driver) inquires as to the status of the printer and receives this status. More specifically, the host transmits a status request to the printer at fixed time intervals, for example five second intervals (S10). In so doing, the host can verify that the printer is capable of printing prior to transmitting print data to the printer.

Having received the status request, the printer transmits a status information response to the host (S20) Information regarding the printer is included in the status information, and when an error occurs on the printer side, for example paper depletion, a paper jam, or ink depletion, the printer transmits error information-attached status information. By means of this information, the host is able to learn the status of the printer. If the host receives printer error information-attached status information, print data are not transmitted to the printer.

When the host receives the status information response and learns thereby that the printer is in a normal state and capable of printing, print data are transmitted to the printer. The printer receives the print data and begins printing (S30).

If the operator wishes to cancel the print data during printing due to a mistake in the paper size or confusion between cut paper and roll paper, for example, the print data may be canceled by pressing the panel switch on the printer (S40).

If the operator presses the panel switch 21C on the printer, the status management unit 15 in the printer transmits a data cancellation request to the status information creation unit 19, and the request is added to the status information. At this time, the printer causes an LED corresponding to the depressed panel switch or the switch itself to flash or the like in response to the switch operation by the operator, and thus the operator can learn that the printer has issued a data cancellation request to the status information creation unit.

The printer then immediately halts printing, whereupon one sheet of the paper used during printing is discharged and the mechanically operating portions in the printing unit such as the carriage return and paper feeder are stopped. The printer then enters data discarding mode (S70) and discards one page of data. As described above, discarding means that printing is halted, and includes the erasure of the print data itself or the cessation of printing while the printer continues to hold the print data.

As the printer stops printing, the printer transmits data cancellation request-attached status information to the host (S90) in response to a status request transmitted from the host (S80).

The host cancels the print job for which cancellation is requested, and erases the held data (S95). If the host is holding a plurality of print jobs, only the job for which cancellation has been requested is canceled. Since the host deletes the print job in response to the data cancellation request-attached status information from the printer (S90), the operator need not take the trouble of moving to the host to delete the print job.

Next, the host transmits a reset command (initialization request) to the printer in response to the data cancellation request (S100). If resetting is executed independently on the printer side, the host does not detect that the printer is being reset, but since the host is caused to transmit a reset command, the host can detect that the printer has begun a reset operation. After transmitting the reset command, the host transmits no more print data to the printer. However, received print data until the panel switch is depressed are discarded by the printer.

When the printer receives the reset command from the host (S100), status information that a cancellation operation is underway (S110) is transmitted in response to the host. This status information that a cancel operation is underway (S110) is particularly useful when a plurality of hosts are connected to the printer, as described above.

This is because although the host which transmitted the reset command (S100) knows that the printer is being reset, the other hosts do not know this information. By having the printer transmit the status information that a cancel operation is underway (S110) to the host, the other connected hosts can also learn that the printer is being reset. Hence the other connected hosts also stop transmitting print data to the printer.

Next, the printer executes internal reset processing and deletes all of the data stored in the RAM, for example in the internal reception data buffer and image buffer (S120).

When this reset processing is complete, the printer informs the host of status information indicating normal status (S130). By means of this status information indicating normal status (S130), the host learns that printer resetting is complete, and thus resumes normal printing processing in succession from the subsequent job to the canceled job. The print data for the canceled print job are erased on the host side, and hence no canceled print data are transmitted to the printer following the return of the printer to normal status. As a result, normal printing of the next job can be started immediately.

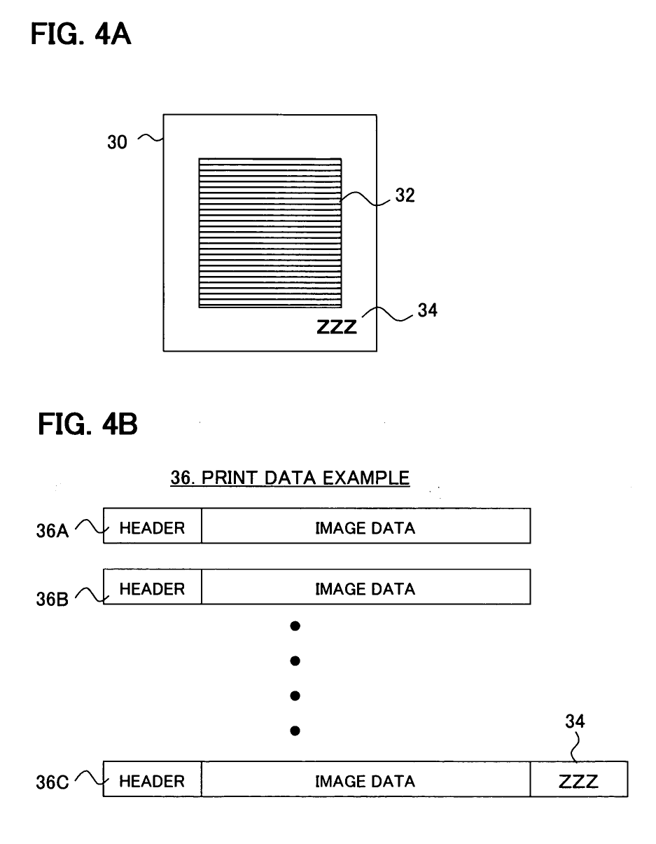

FIG. 4 is a view showing an example of a printed image and the print data thereof. In the embodiment described above, the printer halts printing, performs paper discharge, and performs print data discarding processing (S70) in response to a cancellation request from the panel switch of the printer. This print data discarding processing will now be described further.

FIG. 4A shows a typical printed image comprising alphanumeric characters, graphics, or images 32 on a sheet of printing paper 30. A predetermined code 34 (“ZZZ”, for example) indicating the end of the printed images is attached to the end of the printed images. This predetermined code 34 is attached by the host driver in a large number of printer languages. As shown in FIG. 4B, print data 36 for the printed images are constituted by band data 36A, 36B, 36C comprising a header and image data for each of a plurality of bands into which one page is divided. The predetermined code 34 indicating the end of the printed images is attached to the final band data 36C.

In the embodiment described above, for this type of print data, in response to a cancellation request from the panel, the printer retrieves the print data inside the reception data buffer 5 and discards the print data up to the predetermined code 34 (skipping over the print data without performing data processing so as to substantially scrap the data). By performing printing cessation, paper discharge processing, and print data discarding processing only in response to a cancellation request from the panel in this manner, wasteful printing can be avoided even when a reset command is not transmitted from the host printer driver due to certain circumstances.

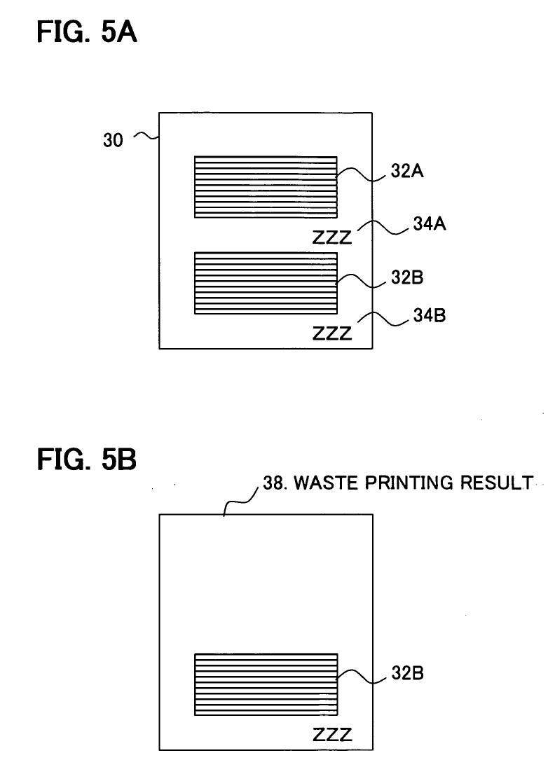

FIG. 5 is a view showing an example of a printed image and waste printing. FIG. 5A is a rare example of a printed image in which two printed images 32A, 32B exist on the printing paper 30 and predetermined codes 34A, 34B are provided at the end of each image. When a cancellation request is issued from the printer panel for this type of printed image, the predetermined code 34A at the end of the image 32A is detected using the aforementioned data discarding processing, and discarding processing is performed only on the data up to that point. Since discarding processing is not performed for the print data of the image 32B on the same page, the printer performs wasteful printing processing of the print data comprising the following image 32B and predetermined code 34B. As a result, waste printing of the image 32B is executed as shown in FIG. 5B.

In the above embodiment, the printer performs internal reset processing in response to a reset command from the host driver even for such exceptional print data, and thus the waste printing shown in FIG. 5B can be avoided. More specifically, the printer informs the host of the data cancellation request status, thereby causing the host driver to transmit a reset command. In response to the reset command, the printer performs printer internal reset processing. By means of this printer internal reset processing, all of the print data stored in the reception data buffer 5 are cleared. The expanded image data inside the image buffer 11 are also cleared. Error removal is then performed by executing mechanical resetting in respect of the error which caused the cancellation request, for example a paper depletion error. Thus internal reset processing is performed even for the print data of an image such as that shown in FIG. 5, whereby the print data is scrapped and waste printing is wholly avoided.

In the printer internal reset processing, all of the received print data in the reception data buffer are scrapped. Accordingly, if the print data for a plurality of jobs is stored in the reception data buffer, the print data for print jobs other than the print job that is the subject of the cancellation request may be scrapped. Hence this embodiment is preferably designed to a one connection-one job specification whereby upon reception of a print job, the printer does not accept the next print job until processing for the accepted print job is complete. If this design specification is adhered to, only the print data for the print job that is the subject of a cancellation request are discarded from the reception data buffer and image buffer when the printer performs internal reset processing in response to a reset command, and the print jobs other than that of the cancellation request are not canceled.

[Self-resetting]

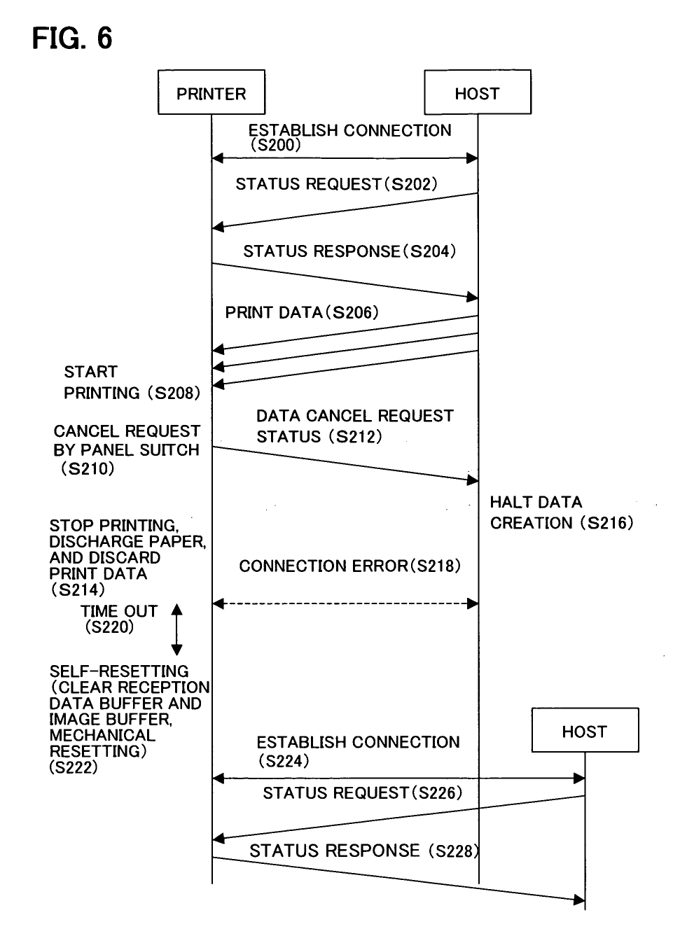

FIG. 6 is a sequence chart in a modified example of this embodiment. This is an example in which a printer is shared by a plurality of host computers through a network such as a LAN. In the drawing, two host computers are depicted. When a host computer is to request a print job of the network printer, first a network connection must be established (S200). Once the connection has been established, similarly to the example in FIG. 3, the host computer transmits a status request to the printer (S202) to inquire as to the status of the printer. In response thereto, the status information creation portion 19 of the printer informs the host computer of the status (S204). If an error has occurred, such as paper depletion or ink depletion, the host computer waits for the status to return to normal and does not transmit print data. The status request S202 is transmitted every few seconds, for example, and the printer informs the host computer of its status in response to every status request.

When the status eventually returns to normal, the host driver successively transmits print data (S206). In popular printers such as ink jet printers, for example, the capacity of the reception data buffer is limited, and hence printing is begun when the print data of one scanning movement of the ink head are received (S208) rather than when all of the print data for one page are received. If an error such as a paper depletion error or paper size error occurs when printing has begun and appropriate paper is unavailable, a cancellation request is issued by an operator through the panel switch of the printer (S210) whereby the printer immediately stops printing, discharges the paper, and performs discarding processing up to the predetermined code of the print data (S214). Simultaneously, the printer transmits the data cancellation request status to the host (S212).

In the example in FIG. 3, in response thereto the host driver halts data creation and transmits a reset command. However, the host is sometimes unable to transmit a reset command to the printer due to a certain reason. For example, the operator may disconnect the LAN cable, or it may be impossible to transmit a command code such as a reset command according to the specifications of the network itself. In such a case, a network control unit provided in the printer detects a connection error (S218) and informs the status management unit 15 of the printer that the connection has been severed.

In the modified example of FIG. 6, when the status management unit 15 detects a time-out of a predetermined length of time from the occurrence of the connection error, the status management unit 15 executes self-resetting, which is provided as a function of the printer (S222). Self-resetting is similar reset processing to the internal resetting performed in response to the aforementioned reset command. The data in the reception data buffer 5 and image buffer 11 are cleared by the status management unit 15, and mechanical resetting is also performed. Mechanical resetting is reset processing of the mechanical parts whereby the head is returned to the home position by a carriage motor, paper is discharged by a paper feeding motor, the ink jet nozzle is initialized, and so on. Thus when a reset command from the host driver cannot be received due to a connection error or the like, the network printer detects hang-up status by means of a time-out, assumes this to be a connection error, and executes self-resetting. As a result, the data in the reception data buffer and image data buffer are scrapped and waste printing is avoided.

This self-resetting processing is only to be used in times of emergency. When a reset command can be received normally, the printer simply clears the data in the reception data buffer and image buffer, and thus printing processing can be resumed upon reception of the next print job without executing time-consuming mechanical resetting. Self-resetting processing, on the other hand, includes mechanical resetting.

When initialization processing through self-resetting is complete, the next print job can be received. In the example in FIG. 6, a connection is established with a different host (S224), and as described above, a status request is transmitted to the printer from the host driver (S226), in response to which the host is informed that the status of the printer is normal (S228). Thereafter, processing continues as described above.

[Second Embodiment]

In the first embodiment described above, a cancellation of a specified print job is not performed between the host and printer. The first embodiment is basically premised on the fact that the host and printer are connected one-to-one on a bi-directional communication channel such as a USB cable. However, when a cancellation request is placed from the panel, print data are discarded up to the predetermined code, and thus even when a reset command cannot be communicated in the case of a network connection, minimal printing cancellation is possible.

In the second embodiment, on the other hand, a job ID is attached to the print data, and a job start command and job end command are also attached to the print data. Hence the job information which is subject to cancellation is shared by the host and printer, enabling cancellation processing to be performed only in respect of a designated job. In this case also, waste printing can be avoided and print jobs can be canceled even during emergency situations in which the aforementioned commands cannot be transmitted due to a network error or the like.

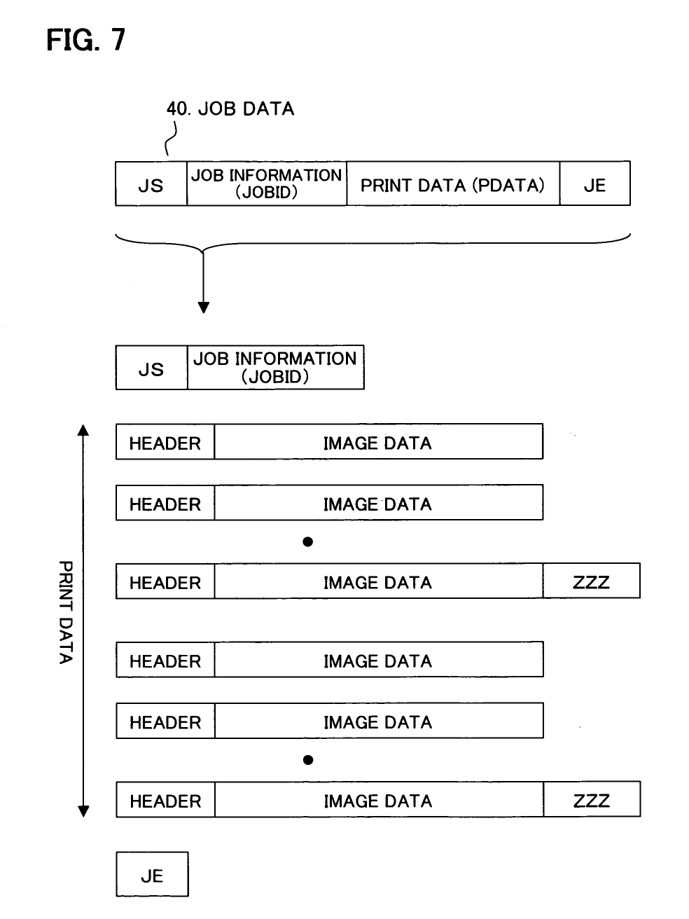

FIG. 7 is a view showing the constitution of print data in the second embodiment. In this embodiment, a job start command JS and a job end command JE are attached to the front end and rear end of the print data PDATA so that the front end and rear end of a print job can be distinguished. Job identification information JOBID for identifying the job is also attached. The job identification information enables identification of the type of print job and the host from which the job was transmitted. As shown in FIG. 7, the print data are a set of print data in band units comprising a header and image data, similarly to the data shown in FIG. 4B. Image data management commands such as color information, resolution information, data length, and compression method information are included in the header.

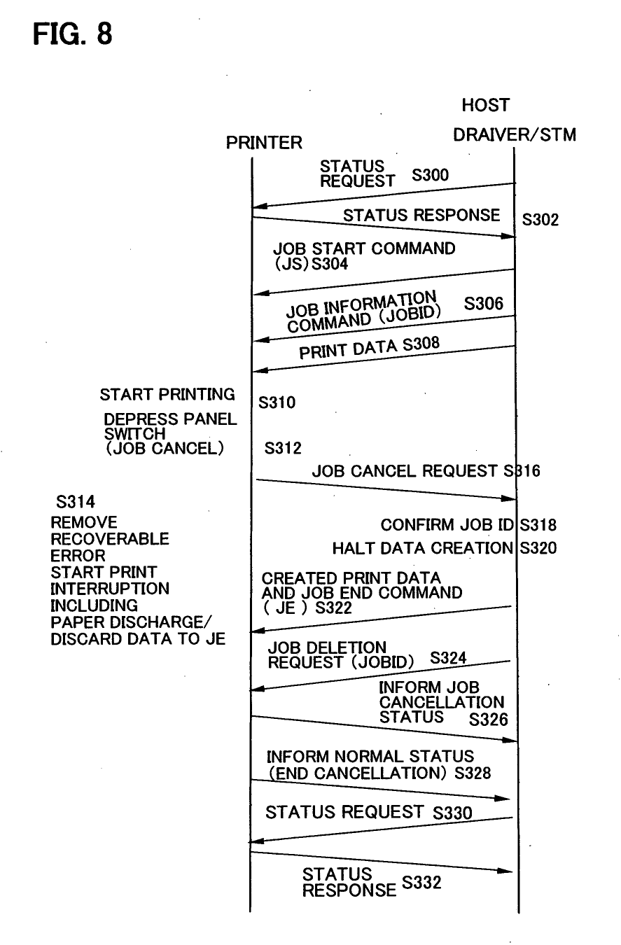

FIG. 8 is a sequence chart for canceling a print job from the panel switch of the printer in the second embodiment. A printer driver is installed in the host computer, and status management means (STM) for managing the status of the printer are provided. As shown in FIG. 8, when printing is started, the driver transmits a status request to the printer (S300), in response to which the printer informs the driver of its current status (S302). If the current status is normal and no errors have occurred, the driver transmits the job start command JS indicating the start of a print job (S304) and the job identification information command JOBID (S306), and then transmits the print data (S308). In response thereto, the printer starts printing (S310). Status requests and status responses continue to be communicated every few seconds even after printing has begun, and by means of this interaction, the driver obtains job identification information for the job which is currently being printed.

If, once printing has begun, an operator manipulates the job cancellation switch on the printer panel in order to cancel a print job due to an error such as a paper size error (S312), the printer immediately stops printing in response to the switch operation, and then discharges the paper and begins discarding processing on the remaining print data (S314). At the same time, the printer transmits a job cancellation request to the driver as a response to the status request (S316). At the reception of the status indicating a job cancellation request, the driver has already acquired the job identification information for the job which is subject to cancellation. Alternatively, the job identification information JOBID may be transmitted at the time of this status response transmission. If the error at that time is unique to the job subject to cancellation, unlike a paper depletion error, such that the printer can recover without assistance from the operator, then the printer removes the error to enable subsequent data reception.

When the driver receives notification of the job cancellation request, the driver determines whether the request refers to the print job currently being created (S318). If a match is made, data creation is halted and the job end command JE is attached to the print data being created. This is transmitted to the printer, whereupon print data transmission is halted (S322). If a match is not made, this indicates that transmission of the print data that is subject to cancellation is complete, and thus the driver continues to create the print data currently being created. Note, however, that the driver always attaches the job end command JE to the end of the print data such that the job end command JE is attached to the transmitted print data stored in the reception data buffer of the printer. The driver also transmits a job deletion request command to the printer together with the job identification information JOBID (S324). The order of steps S322 and S324 may be reversed.

In response to the job deletion request command, the printer transmits to the driver a status indicating that job cancellation is underway (S326). The printer continues the printing cancellation processing of step S314 and executes data discarding processing up to the job end command JE of the received print data. Thus even when a plurality of jobs have been received, discarding processing may be performed only on the print data of the print job for which printing has been canceled. In the printing cancellation processing of step S314, the driver is notified of the status that job cancellation is underway in response to a status request from the driver (S326). When discarding processing of the print data is complete, the printer notifies the driver that cancellation is complete in the form of a status response (S328). In response to this notification, the driver transmits a status request S330, and if a status response indicating normal status is received (S332), the driver transmits the data for the next print job.

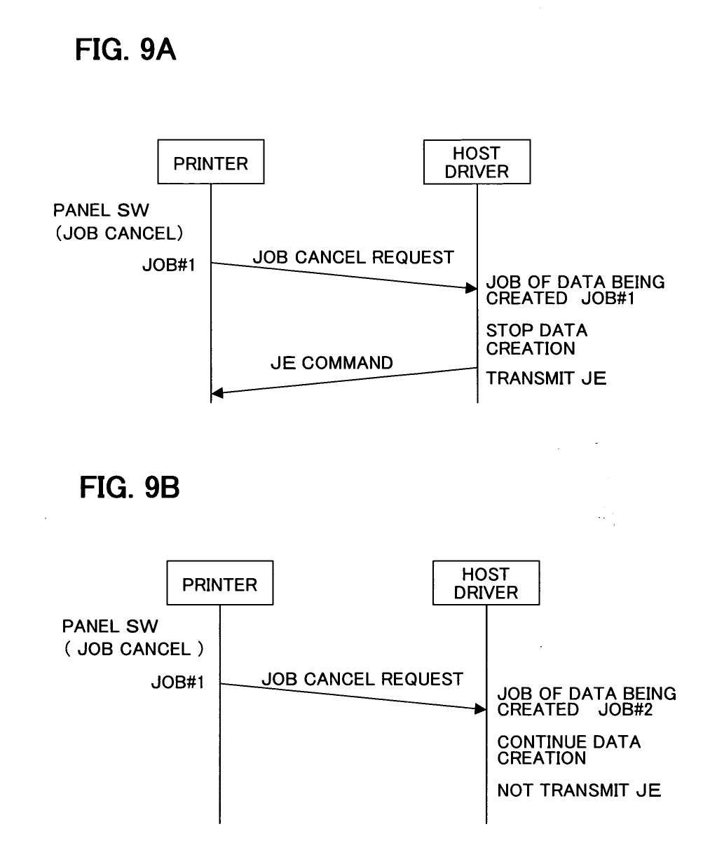

FIG. 9 is a view illustrating an operation on the driver side for responding to a job cancellation request in the second embodiment. FIG. 9A illustrates a case in which, when job cancellation is requested from the panel switch of the printer, the job ID of the job being printed is JOB#1, and the job ID of the data being created on the host driver side when the job cancellation request is received is also JOB#1, and therefore matches the job ID of the job being printed. In this case, the host driver halts the data creation that is currently underway, attaches the job end command JE to the print data, and transmits this to the printer.

FIG. 9B, on the other hand, illustrates a case in which, when job cancellation is requested from the panel switch of the printer, the job ID of the job being printed is JOB#l, but the job ID of the data being created on the host driver side when the job cancellation request is received is JOB#2, and therefore does not match the job ID of the job being printed. In this case, data creation is continued and a job end command is not transmitted. By attaching job identification information in this manner, if print data for the next job is already being created on the driver side when a panel cancellation request is issued from the printer, the creation of these data is not halted, and therefore even though a time lag occurs, data creation is prevented from being halted inappropriately.

In the second embodiment as described above, job identification information, a job start command, and a job end command are added, and in response to a job cancellation request, the job end command is attached to print data on the driver side and transmitted to the printer. Thus data discarding processing can be performed on the printer side in respect of only the print job that is the subject of the cancellation request.

In the second embodiment, a job end command must be received from the driver side in order for the printer side to perform print data discarding processing appropriately. However, similarly to the first embodiment, even when a job end command cannot be received due to a network breakdown, inadequate specification, or the like, job cancellation must be performed such that waste printing is prevented.

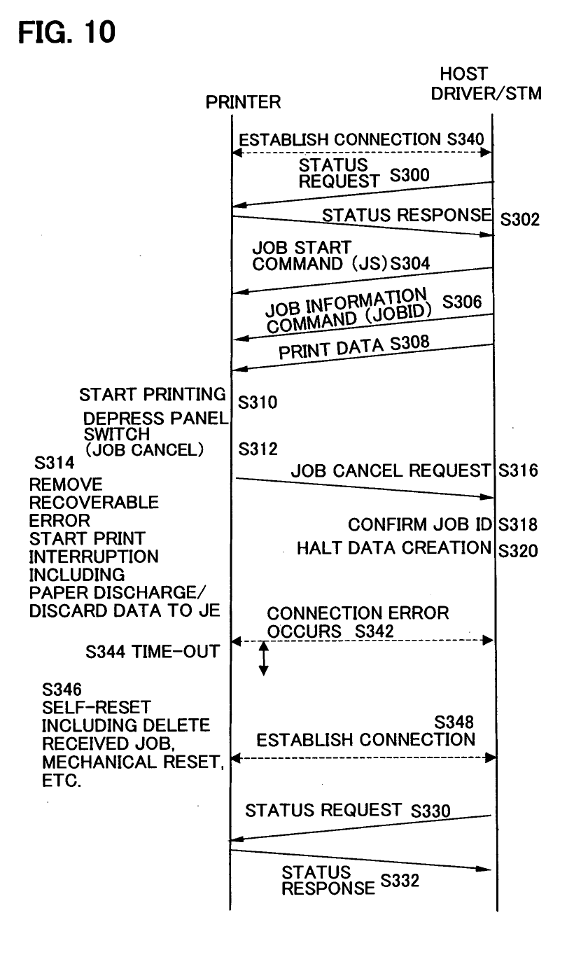

FIG. 10 is a sequence chart illustrating print job cancellation when an emergency situation such as a network connection error occurs. Identical steps to those in FIG. 8 have been allocated identical reference numbers. First, when a print job is requested, the host establishes a connection with the printer (S340). Thereafter, the status request S300, status response S302, job start command transmission S304, job identification information transmission S306, print data transmission S308, and printing commencement S310 are as described in FIG. 8. Similarly to FIG. 8, if a job cancellation request is issued using the printer panel switch once printing has begun (S312), the printer halts printing, discharges the paper, and begins print data discarding processing (S314). The printer also removes errors from which it can recover. The printer then transmits a job cancellation request to the driver as a status response (S316). The driver uses the job identification information to check for a match with the print job currently being processed (S318), and if a match is made, the driver halts data creation for the print job (S320). Processing up to this point is identical to that of FIG. 8.

In the example in FIG. 10, when an emergency situation occurs such as cutting of the network cable, inability to transmit a job end command according to the network specifications, or inability to receive data via an established connection, a network card connected to or installed in the printer detects a connection error by means of a time-out (S342, S344). If data are not received for a predetermined length of time, the network is considered to be closed, and the printer begins self-resetting (S346). In this self-resetting, all of the data for a received print job are deleted, and mechanical resetting for resetting the head, paper-supply mechanism, and so on is performed. Thus received print data can be deleted entirely even when the job end command JE cannot be received from the driver side, and subsequent waste printing can be avoided.

When self-resetting is complete, a new connection is established (S348), whereupon status requests S330 and status responses S332 are transmitted and the subsequent printing processing is performed. All of the print data subject to cancellation are scrapped by self-resetting, and thus meaningless waste printing caused by remaining print data mixing with new print data is avoided.

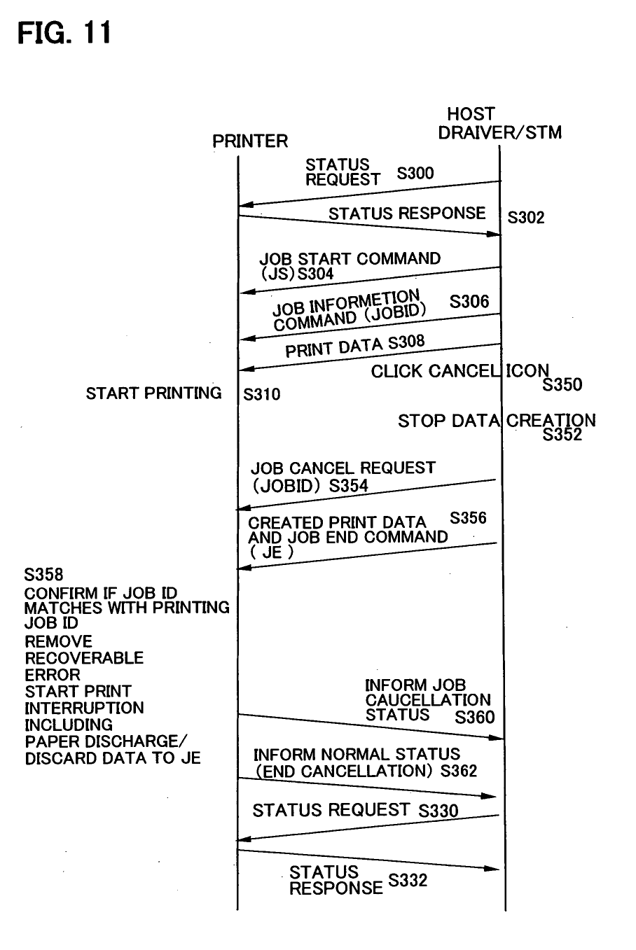

FIG. 11 is a sequence chart for a case in which a print job is canceled from the host side. According to the second embodiment described above, similar specifications can be applied when a print job is canceled from the host side. In FIG. 11, processing from the status request S300 to printing commencement S310 is identical to the processing in FIG. 8. If a cancellation request is issued from the status management means STM in the host driver once printing has begun (S350), the cancellation request is transmitted to the driver, whereupon the driver cancels generation of the corresponding print data such that data generation is not performed thereafter (S350). The driver then transmits a job cancellation request to the printer together with the job identification information JOBID (S354), and also attaches the job end command JE to the created print data which is then transmitted to the printer (S356).

The printer then verifies whether the print data corresponding to the job identification information JOBID specified by the job cancellation request are currently being printed, and if a match is made, printing is halted, paper is discharged, and print data discarding processing is performed up to the job end command (S358). At this time, removable errors are eliminated. If the print data corresponding to the job cancellation request are not yet being printed, printing processing is not halted, and the print data in the reception data buffer which correspond to the job identification information JOBID are scrapped up to the job end command. Hence, even though a time lag occurs between the job cancellation request and printing, it is possible to scrap only the print job corresponding to the job cancellation request.

The print job cancellation processing in FIG. 11 is identical to the sequence in FIG. 8 of the second embodiment from step S318 onward, and thus print job cancellation from the printer panel switch and cancellation from the driver side can be executed by the same printer driver.

By using the self-resetting function described in FIG. 10, cancellation from the spooler of the host computer operating system (OS) is also possible. More specifically, when a job cancellation request is issued from the spooler such that the OS ceases to output print data for the driver, data transfer over the network connection is disrupted. In other words, this is a similar situation to when the host is hung up. As described above, this type of situation is detected as a network error, and thus the printer performs self-resetting processing such that the print job data are scrapped.

In the second embodiment described above, a job end command is received from the host driver, and print data discarding processing is performed up to the command. If the job end command cannot be received for some reason, however, a connection error is detected and self-resetting is performed, thereby avoiding waste printing. Accordingly, it is preferable that the printer accept only one print job per connection. It is also preferable that the printer does not accept another print job until the received print job is complete. In so doing, print data inside the reception data buffer are forcibly scrapped during self-resetting, but print data not subject to cancellation can be prevented from being scrapped.

The present invention is capable of canceling a print job from the printer side such that the print data subject to cancellation are scrapped. Since this enables the prevention of waste printing, the present invention is useful for a terminal printer.

1. A printer which receives print data from a host and prints an image corresponding to said print data,
wherein said printer supplies a data cancellation request to said host in response to an operation on said printer, so as to cause the host to delete print data held by said host.

2. The printer according to claim 1, wherein, when the host holds a plurality of print jobs, the print data that is deleted by said host is the print data for the job which corresponds to said operation on the printer.

3. The printer according to claim 1 which receives print data from a host and prints an image corresponding to said print data,
wherein said printer halts printing corresponding to received print data in response to an operation on the printer.

4. A printer which receives print data from a host and prints an image corresponding to said print data,
wherein said printer causes said host to transmit an initialization request to the printer in response to an operation on the printer, and initializes an interior of the printer in response to said initialization request.

5. The printer according to claim 4, wherein the printer transmits a notification that initialization is being executed to said host in response to said printer initialization request.

6. The printer according to any one of claims 1 through 5, wherein said operation on the printer includes depression of a panel switch on the printer, and in response to said data cancellation request, the printer causes said depressed panel switch or a light-emitting portion thereof to flash.

7. A printer which receives print data from a host and prints an image corresponding to said print data, comprising:
printing cancellation means which, during the printing of an image corresponding to received print data, in response to a printing cancellation request operation on an operating panel of the printer, halt said printing, perform discarding processing of received print data up to a code which indicates a predetermined end-point, and transmit a data cancellation request to the host to have the host halt a transmission of print data; and
internal reset processing means which, in response to a reset command transmitted from the host in response to said data cancellation request, perform an internal reset processing to scrap received print data and transmit to the host a status response indicating that cancellation is underway.

8. The printer according to claim 7, wherein print job identification information is not attached to said print data.

9. The printer according to claim 7, further comprising self-resetting means which perform self-resetting processing including processing to scrap received print data inside the printer, when data are not received from the host for a predetermined length of time following the transmission of said data cancellation request to the host by said printing cancellation means.

10. The printer according to claim 9, wherein said self-resetting processing includes mechanical resetting processing which includes an operation to return a position of a head inside the printer to a home position.

11. A printer which receives print data from a host and prints an image corresponding to said print data, comprising:
printing means which execute a print job after receiving, from the host, print job data including job identification information and print data and having a job end command attached to the end thereof;
printing cancellation means which, during printing corresponding to received print job, in response to a printing cancellation request operation on an operating panel of the printer, halt said printing and transmit a data cancellation request to said host to cause said host to halt transmission of the print data for said print job, to attach said job end command to the print job data corresponding to said print job, and to transmit said job end command to said printer;
discarding processing means which perform discarding processing of received print data inside said printer up to said job end command; and
self-resetting means which perform self-resetting processing including processing to scrap received print data inside the printer, when data are not received from the host for a predetermined length of time following the transmission of said data cancellation request to the host by said printing cancellation means.

12. The printer according to claim 11, wherein said self-resetting processing includes mechanical resetting processing which includes an operation to return a position of a head inside the printer to a home position.

13. The printer according to claim 11, wherein the printer does not accept data for a next print job until printing processing for received print job data is complete.

14. A print job cancellation method for a printer which receives print data from a host and prints an image corresponding to said print data, comprising the step of supplying a data cancellation request to said host in response to an operation on said printer, thereby causing the host to delete print data held by said host.

15. A print job cancellation method for a printer which receives print data from a host and prints an image corresponding to said print data, comprising the steps of:
causing said host to transmit an initialization request to the printer in response to an operation on the printer; and
initializing an interior of the printer in response to said initialization request.

16. A print job cancellation method for a printer which receives print data from a host and prints an image corresponding to said print data, comprising the steps of:
canceling printing, during the printing of an image corresponding to received print data, in response to a printing cancellation request operation on an operating panel of the printer, by halting said printing, performing discarding processing of received print data up to a code which indicates a predetermined end-point, and transmitting a data cancellation request to the host to have the host halt a transmission of print data; and
performing an internal reset processing to scrap received print data in response to a reset command transmitted from the host in response to said data cancellation request, and transmitting to the host a status response indicating that cancellation is underway.

17. A print job cancellation method for a printer which receives print data from a host and prints an image corresponding to said print data, said printer comprising printing means which execute a print job after receiving, from the host, print job data including job identification information and print data and having a job end command attached to the end thereof, said method comprising the steps of:
canceling printing, during printing corresponding to a received print job, in response to a printing cancellation request operation on an operating panel of the printer, by halting said printing and transmitting a data cancellation request to said host to cause said host to halt transmission of the print data for said print job, to attach said job end command to the print job data corresponding to said print job, and to transmit said job end command to said printer;
performing discarding processing of received print data inside said printer up to said job end command; and
performing self-resetting processing including processing to scrap received print data inside the printer, when data are not received from the host for a predetermined length of time following the transmission of said data cancellation request to the host in said step of canceling printing.
